(19) United States
(12) Patent Application Publication
(10) Pub. No.: US 2022/0138688 A1
(43) Pub. Date: May 5, 2022

(54) SYSTEMS AND METHODS FOR DISTRIBUTED LEDGER-BASED MANAGEMENT OF METADATA AND CHAIN OF CUSTODY OF DOCUMENTS

(71) Applicant: JPMORGAN CHASE BANK, N.A., New York, NY (US)

(72) Inventors: Laura SCHORNACK, Oak Park, IL (US); Olisa OKPOKO, New York, NY (US); Boyang GONG, New York, NY (US); Nathan MCGOVERN, New York, NY (US); James WEI, New York, NY (US); Jae Wook LEE, New York, NY (US); Jesse WU, New York, NY (US)

(21) Appl. No.: 17/087,425

(22) Filed: Nov. 2, 2020

(51) Int. Cl. G06Q 10/10; G06F 16/27; G06F 16/93; G06F 21/62; G06Q 30/00; G06Q 40/02; H04L 29/08

(52) U.S. Cl. CPC G06Q 10/10; G06F 16/27; G06F 16/93; G06Q 2220/00; G06Q 30/018; G06Q 40/02; H04L 67/10; G06F 21/6218

(57) ABSTRACT

Systems and methods for distributed ledger-based management of metadata and chain of custody of documents among financial intuitions are disclosed. In one embodiment, a method may include: (1) receiving from internal storage for the first entity, a document or file to share with a second entity; (2) at least one first entity uploading the document or file to a first entity document sharing application; (3) saving the document or file to temporary storage a distributed ledger node for the first entity, the distributed ledger node part of a distributed ledger network; (4) writing the document or file to a first entity distributed ledger; and (5) writing metadata for the document or file to the first entity distributed ledger. A second entity document sharing program may retrieve the document or file from the first entity document sharing program into a distributed ledger node for the second entity.

### BACKGROUND OF THE INVENTION

### 1. Field of the Invention

The present disclosure relates to systems and methods for distributed ledger-based management of metadata and chain of custody of documents among financial intuitions.

### 2. Description of the Related Art

Financial institutions often share files and documents with each other. These documents are normally communicated by email, fax, or even standard mail services. Once the document is sent, there is no way to track the document.

### SUMMARY OF THE INVENTION

Systems and methods for distributed ledger-based management of metadata and chain of custody of documents among financial intuitions are disclosed. In one embodiment, a method for distributed ledger-based management of metadata and chain of custody of documents may include: (1) receiving from internal storage for the first entity, a document or file to share with a second entity; (2) at least one first entity computer processor uploading the document or file to a first entity document sharing application; (3) saving the document or file to temporary storage a distributed ledger node for the first entity, the distributed ledger node part of a distributed ledger network; (4) writing the document or file from the temporary storage to a first entity distributed ledger; and (5) writing metadata for the document or file to the first entity distributed ledger, wherein the metadata for the document or file is replicated to a second entity distributed ledger. A second entity document sharing program retrieves the document or file from the first entity document sharing program into temporary storage a distributed ledger node for the second entity in response to the metadata being replicated on the second entity distributed ledger.

In one embodiment, a second entity computer processor may download the document or file from the temporary storage a distributed ledger node for the second entity.

In one embodiment, the second entity may upload the document or file into a second entity document management system.

In one embodiment, the second entity may associate the metadata with the document or file in the second entity document management system.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for distributed ledger-based management of metadata and chain of custody of documents among financial intuitions according to an embodiment; and

FIG. 2 depicts method for distributed ledger-based management of metadata and chain of custody of documents among financial intuitions according to an embodiment.

### DETAILED DESCRIPTION OF PREFERRED EMBODIMENTS

Systems and methods for distributed ledger-based management of metadata and chain of custody of documents among financial intuitions are disclosed. Embodiments facilitate the tracking of files and documents using the documents metadata.

Examples of documents and files that may be shared include a Wolfsberg document that evidences the financial institution's documentation of anti-money laundering (AML), know your customer (KYC), and counter terrorist financing (CTF) review. Other documents and files may be shared as is necessary and/or desired.

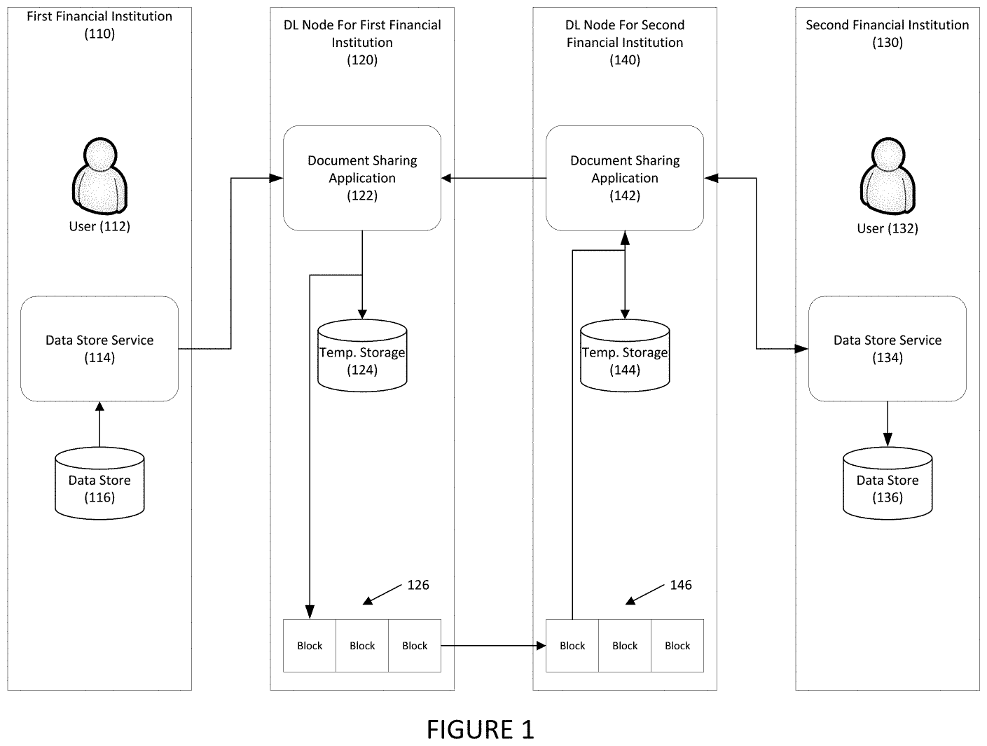

Referring to FIG. 1, a system for distributed ledger-based management of metadata and chain of custody of documents among financial intuitions is disclosed according to one embodiment. The system may include first financial institution 110 and second financial institution 130. It should be noted that although FIG. 1 depicts two financial institution, it should be noted that additional financial institutions may be included as is necessary and/or desired.

In one embodiment, first financial institution 110 may include data store 116 and data store services 114. In one embodiment, data store 116 may store documents that may be shared with, or received from, other financial institutions, such as second financial institution 130. In one embodiment, include data store 116 and data store services 114 may be behind a firewall.

First financial institution 110 may further include user 112, which may be a human, and automated process, or a combination thereof.

Second financial institution 130 may include data store 136 and data store services 134. In one embodiment, data store 136 may store documents or files that may be shared with, or received from, other financial institutions. In one embodiment, include data store 136 and data store services 134 may be behind a firewall.

First financial institution 110 may further include user 112, which may be a human, and automated process, or a combination thereof. Similarly, second financial institution 130 may further include user 122, which may be a human, and automated process, or a combination thereof.

First financial institution 110 and second financial institution 130 may participate in a distributed ledger network. An example of such a distributed ledger network is the Interbank Information Network, or IIN. Other distributed ledger networks may be used as is necessary and/or desired.

In one embodiment, first financial institution 110 may particulate as distributed ledger node 120, and second financial institution 130 may participate as distributed ledger node 140. Node 120 and node 140 may include document sharing application 122 and 142, respectively. Document sharing application 122/142 may be an application that facilitates sharing documents securely on a distributed ledger network. Exemplary embodiments are disclosed in U.S. Provisional Patent Application Ser. No. 62/972,560, the disclosure of which is hereby incorporated, by reference, it its entirety.

Nodes 120 and 140 may further include temporary storage 124 and 144, respectively, which may be used to store files and/or data that are being written to or read from the distributed ledger.

Nodes 120 and 140 may maintain copies of distributed ledger 126 and 146, respectively, and may read and/or write to the distributed ledgers.

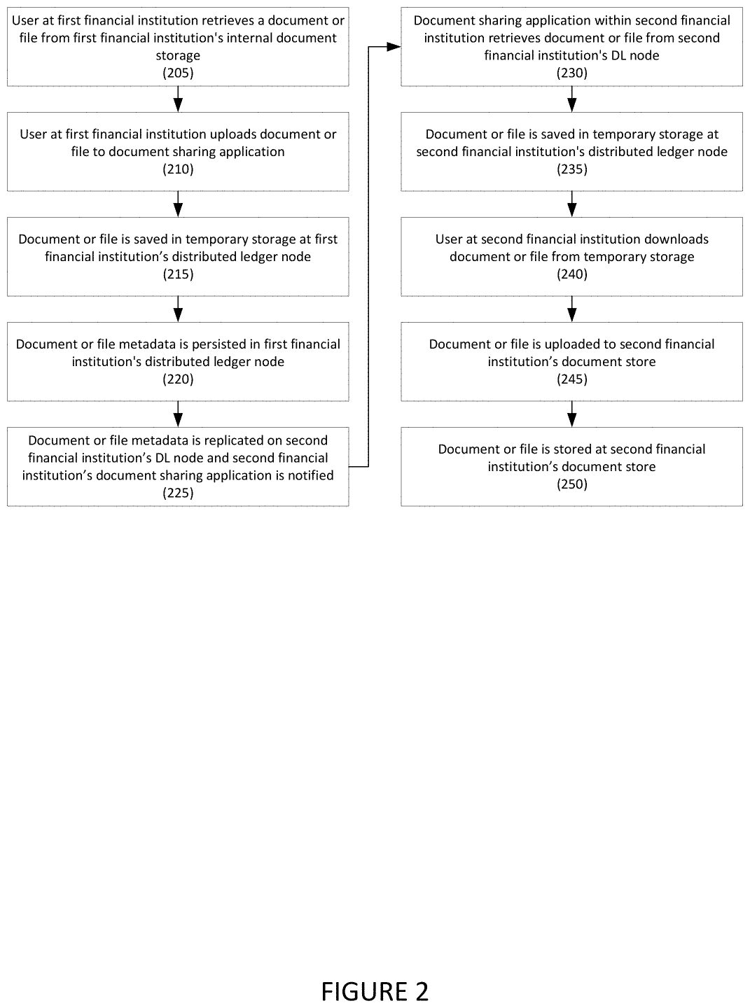

Referring to FIG. 2, a method for distributed ledger-based management of metadata and chain of custody of documents among financial intuitions is disclosed according to one embodiment.

In step 205, a user at a first financial institution may retrieve a document or file from the first financial institution's internal document storage to share with a second financial institution. In one embodiment, the user may be an individual, an automated program, combinations thereof, etc. The file may be requested by the second financial institution, or the first financial institution may be distributing the file to the second financial institution. The first financial institution may also classify the second financial institution based on a set of rules that exist between the first financial institution and the second financial institution. The first financial institution may apply a permission set to the file based on the classification of the second financial institution.

In one embodiment, the document or file may be a new file, and update to an existing file, etc.

In one embodiment, the document or file may be shared with a plurality of financial institutions.

In step 210, the document or file may be uploaded to a document sharing application at the first financial institution. An example of a suitable document sharing application is disclosed in U.S. Provisional Patent Application Ser. No. 62/972,560, the disclosure of which is hereby incorporated, by reference, it its entirety.

In step 215, the document or file may be saved in temporary storage at the first financial institution's distributed ledger node, and in step 220, the file metadata for the document or file may be written to the copy of the distributed ledger at the first financial institution.

In step 225, once the file metadata is written to the distributed ledger, it is replicated at the copy of the distributed ledger maintained by the second financial institution. The second financial institution's document sharing application is notified of the document or file on the distributed ledger.

In step 230, the second financial institution's document sharing application may retrieve the document or file from the first financial institution's document sharing program, and in step 235, the document or file may be saved in temporary storage at the second financial institution's distributed ledger node.

In step 240, a user at the second financial institution may download the document or file from temporary storage in the second financial institution's distributed ledger node, and in step 245, the document or file may be uploaded to the second financial institution's document store, which may be behind a firewall. In step 250, the document or file may be stored in the document store. In one embodiment, the document metadata may be associated with the file so that the file may versioned and tracked.

Although multiple embodiments may have been disclosed, it should be recognized that these embodiments are not exclusive to each other, and features from one may be used with others.

Hereinafter, general aspects of implementation of the systems and methods of the embodiments will be described.

The system of the embodiments or portions of the system of the embodiments may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the embodiments.

The processing machine used to implement the embodiments may utilize a suitable operating system. Thus, embodiments may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the methods as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the embodiments. Rather, any number of different programming languages may be utilized as is necessary and/or desirable.

Also, the instructions and/or data used in the practice of the embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the embodiments may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the embodiments.

Further, the memory or memories used in the processing machine that implements the embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the embodiments, a variety of “user interfaces” may be utilized to allow a user to interface with the processing machine or machines that are used to implement the embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method of the embodiments may interact partially with another processing machine or processing machines, while also interacting partially with a human user.

It will be readily understood by those persons skilled in the art that the present embodiments are susceptible to broad utility and application. Many embodiments and adaptations other than those herein described, as well as many variations, modifications and equivalent arrangements, will be apparent from or reasonably suggested by the present embodiments and foregoing description thereof, without departing from the substance or scope of the invention.

Accordingly, while the present exemplary embodiments have been described here in detail, it is to be understood that this disclosure is only illustrative and exemplary and is made to provide an enabling disclosure of the invention. Accordingly, the foregoing disclosure is not intended to be construed or to limit the present embodiments or otherwise to exclude any other such embodiments, adaptations, variations, modifications or equivalent arrangements.

What is claimed is:

1. A method for distributed ledger-based management of metadata and chain of custody of documents, comprising:
receiving from internal storage for a first entity, a document or file to share with a second entity;
at least one first entity computer processor uploading the document or file to a first entity document sharing application;
saving the document or file to temporary storage a distributed ledger node for the first entity, the distributed ledger node being part of a distributed ledger network;
writing the document or file from the temporary storage to a first entity distributed ledger; and
writing metadata for the document or file to the first entity distributed ledger, wherein the metadata for the document or file is replicated to a second entity distributed ledger;
wherein a second entity document sharing program retrieves the document or file from the first entity document sharing application into temporary storage a distributed ledger node for the second entity in response to the metadata being replicated on the second entity distributed ledger.

2. The method of claim 1, wherein a second entity computer processor downloads the document or file from the temporary storage a distributed ledger node for the second entity.

3. The method of claim 2, wherein the second entity uploads the document or file into a second entity document management system.

4. The method of claim 3, wherein the second entity associates the metadata with the document or file in the second entity document management system.

5. The method of claim 1, further comprising receiving a request from the second entity, wherein the request comprises an identifier of a document or file associated with a document or file in the custody of the first entity.

6. The method of claim 5, further comprising storing the document or file into a second internal storage for the second entity.

7. The method of claim 1 further comprising:
determining, by the first entity, a security classification of the second entity and assigning a permission set to the document or file based on the security classification.

8. A system for distributed ledger-based management of metadata and chain of custody of documents, comprising:
a first document management system associated with a first entity, wherein the first document management system includes a first internal storage;
a second document management system associated with a second entity, wherein the second document management system includes a second internal storage; and
a controller;
wherein:
the controller receives a document or file from the first document management system to share with the second document management system;
the first document management system uploads the document or file to a first document sharing application;
the controller saves the document or file to a first temporary storage of a distributed ledger node associated with a first entity, the distributed ledger node being part of a distributed ledger network;
the controller writes the document or file from the first temporary storage to a first entity distributed ledger; and
the controller writes metadata for the document or file to the first entity distributed ledger, and replicates the metadata for the document or file on a second entity distributed ledger;
wherein a second document sharing application retrieves the document or file from the first document sharing application and stores the document or file in a second temporary storage of a distributed ledger node associated with the second entity in response to the metadata being replicated on the second entity distributed ledger.

9. The system of claim 8, wherein a second entity computer processor downloads the document or file from the second temporary storage a distributed ledger node for the second entity.

10. The system of claim 9, wherein the second entity uploads the document or file into a second entity document management system.

11. The system of claim 9, wherein the second entity associates the metadata with the document or file in the second entity document management system.

12. The system of claim 8 wherein the controller receives a request from the second entity, wherein the request comprises an identifier of a document or file associated with a document or file in the custody of the first entity.

13. The system of claim 12 wherein the controller stores the document or file into a second internal storage for the second entity.

14. The system of claim 8 wherein the controller determines a security classification of the second entity and assigning a permission set to the document or file based on the security classification.

15. The system of claim 8, wherein the metadata includes one or more of: a sender, a recipient, a receiving entity, a document type, an application name associated with sharing, or a context of the document.
